(19) United States
(12) Patent Application Publication
(10) Pub. No.: US 2022/0040605 A1
(43) Pub. Date: Feb. 10, 2022

(54) WATER PURIFIER

(71) Applicant: TIANJIN TIANCHUANG BEST PURE ENVIRONMENTAL SCIENCE AND TECHNOLOGY CO.,LTD., Tianjin (CN)

(72) Inventor: Enyu WEI, TIANJIN (CN)

(21) Appl. No.: 16/986,277

(22) Filed: Aug. 6, 2020

(51) Int. Cl. B01D 35/30; B01D 29/13

(52) U.S. Cl. CPC B01D 35/306; B01D 2201/304; B01D 2201/303; B01D 29/13

(57) ABSTRACT

A water purifier, including a connector assembly including a connector body and a flange portion; the connector body includes the first water inlet cavity and the first water outlet cavity; the flange portion is provided with a flange hole; a filter element assembly including an end cover, the outer wall of the end cover is provided with a flange structure accommodated in the flange hole; a filter element cover having a T-shaped water inlet channel communicated with the first water inlet cavity and a water outlet channel communicated with the first water outlet cavity; a filter element having a water purification cavity communicated with the water outlet channel; and a casing fixed on the end cover, a fourth water inlet cavity is provided between the casing and the filter element and communicated with the T-shaped water inlet channel.

### TECHNICAL FIELD

The present disclosure relates to the field of water purification, in particular to a water purifier.

### BACKGROUND

The filtration system in the water purifier is generally the end cover filtration system which is composed of a upper parts and a lower parts with screw thread to open or close. When the filter bottle is disassembled, the bottle body needs to be unscrewed. When the screw between the bottle body and the end cover is too strong, the compression angle of the bottle body is tight and it is difficult to disassemble.

At present, the single-stage filtration system is external pressure type. The water inlet is outside the filter element and is directly connected to the water inlet of the joint. When the pressure is too high, the air in the water will form bubbles after passing through the water inlet, which will impact the water inlet and cause noise.

### SUMMARY

In view of this, the present disclosure is to provide a water purifier that is easy to disassemble and has low noise.

A water purifier, including a connector assembly, wherein the connector assembly includes a connector body and a flange portion integrally formed with the connector body, the connector body includes a first water inlet cavity and a first water outlet cavity; the flange portion is provided with two flange holes; and a filter element assembly, wherein the filter element assembly includes an end cover accommodated in the connector assembly, an outer wall of the end cover is provided with two flange structures, and the two flange structures are respectively accommodated in the two flange holes; a filter element cover accommodated in the end cover, the filter element cover having a T-shaped water inlet channel and a water outlet channel that is not connected to the T-shaped water inlet channel, the T-shaped water inlet channel is communicated with the first water inlet cavity, and the water outlet channel is communicated with the first water outlet cavity; a filter element fixed at one end of the filter element cover, the filter element having a water purification cavity, the water purification cavity is communicated with the water outlet channel; and a casing fixed on the end cover, a fourth water inlet cavity is provided between the casing and the filter element, and the fourth water inlet cavity is communicated with the T-shaped water inlet channel; water before filtration enters the fourth water inlet cavity through the first water inlet cavity and the T-shaped water inlet channel, then passes through the filter element and enters the water purification cavity to purify, and then flows out from the first water outlet cavity through the water outlet channels.

Further, the flange hole is C-shaped, the flange structure is fan-shaped, and the flange structure is configured to rotate into the flange hole when the end cover is accommodated into the connector assembly.

Further, the flange portion further includes a fourth accommodating cavity, and a upper side and a lower side of an inner wall of the fourth accommodating cavity are provided with two transition sections, and the transition section is located at one end of the two flange holes, the fourth accommodating cavity is used to accommodate the flange portion, when the flange portion is accommodated in the fourth accommodating cavity and two ends opposite to each other of the flange structure are abutted on the inner wall of the fourth accommodating cavity respectively, the end cover is rotated by 90°, and the flange structure slides into the flange hole through the transition section.

Further, an interior of the connector body further includes a water inlet boss, a water outlet boss surrounding the water inlet boss, and an interior of the water inlet boss is provided with a first accommodating cavity communicating with the first water inlet cavity, an interior of the water outlet boss is provided with a second accommodating cavity communicating with the water outlet cavity; an interior of the connector assembly is provided with a third accommodating cavity, the first accommodating cavity, the second accommodating cavity and the flange hole are respectively communicated with the third accommodating cavity; the end of the filter element cover far away from the filter element is accommodated in the first accommodating cavity, the T-shaped water inlet channel is communicated with the first accommodating cavity; the end of the end cover away from the filter element is accommodated in the second accommodating cavity and the third accommodating cavity, the water outlet channel is communicated with the second accommodating cavity.

Further, the filter element cover includes a water inlet body, a water outlet body, two extension portions and a second connecting end, the water outlet body is arranged around one end of the water inlet body, the extension part is arranged around one end of the water outlet body, the water outlet main body and the two extension portions are arranged on the second connecting end, a second water inlet cavity is provided in the water inlet body, the water outlet channel is located on the water outlet body, and each of the extension portions is provided with a third water inlet cavity, the second water inlet cavity and the third water inlet cavity together form the T-shaped water inlet channel.

Further, at least one water inlet o-ring is provided between the water inlet body and an inner wall of the first accommodating cavity, and at least one water outlet o-ring is provided between the water outlet body and the end cover, and at least one end cover o-ring is provided between the end cover and an inner wall of the second accommodating cavity.

Further, the water inlet body is provided with a water inlet, and the water inlet is communicated with the first water inlet cavity and the second water inlet cavity.

Further, the water inlet is an asymmetrical arc structure with protrusions.

Further, the end cover includes a first connecting end, and a surface of the flange portion at one end away from the water outlet cavity is in contact with a surface of the first connecting end of the end cover facing to the flange portion.

Further, a section of the end cover away from the connector assembly is provided with a concave stop, one end of the casing is provided with a convex stop, and the concave stop cooperates with the convex stop to connect the end cover and the casing together.

Further, the water purifier further includes a filter element bottom, the filter element bottom is located in the casing, and one end of the filter element bottom is connected to one end of the filter element away from the filter element cover, and the other end is connected and matched with a rib of the casing.

The water purifier provided by the present disclosure, 1) the flange structure with a fan-shape can directly enter the flange hole in a rotating way to cooperate with the flange hole to connect the connector assembly with the filter element assembly, that is, the flange structure can still slide out from the flange hole when the flange structure rotates in the opposite direction, so that the connector assembly and the filter element assembly can be disassembled without tools; 2) T-type inlet channel is used to separate the water before filtration and then enter the filter element to realize water purification. And the gas generated when water before filtration directly enters the water inlet is decomposed into small bubbles after passing through the filter element, with the same filtering accuracy as that of the filter element, and is discharged from the water outlet channel to reduce the filter element noise.

### BRIEF DESCRIPTION OF THE DRAWINGS

FIG. 1 is a perspective view of a water purifier provided by the present disclosure.

FIG. 2 is an exploded view of the water purifier shown in FIG. 1.

FIG. 3 is a sectional view of the connector assembly in the water purifier shown in FIG. 2.

FIG. 4 is a sectional view of the connector assembly in the water purifier shown in FIG. 2 from an another direction.

FIG. 5 is a perspective view of the end cover in the water purifier shown in FIG. 2.

FIG. 6 is an assembly view showing the end cap shown in FIG. 5 and the connector assembly shown in FIG. 3 in the initial state.

FIG. 7 is an assembly view showing the end cap shown in FIG. 5 and the connector assembly shown in FIG. 3 after the end cap is rotated.

FIG. 8 is a sectional view of the filter element cover in the water purifier shown in FIG. 2.

FIG. 9 is a sectional view of the filter element cover in the water purifier shown in FIG. 2 from an another direction.

FIG. 10 is a sectional view of the filter element assembly of the water purifier shown in FIG. 1.

FIG. 11 is a top view of the filter element assembly of the water purifier shown in FIG. 1.

FIG. 12 is a sectional view of the water purifier shown in FIG. 1.

FIG. 13 is a sectional view of the water purifier shown in FIG. 1 from from an another direction.

Notation description of main elements

| | |
|---|---|
| water purifier | 100 |
| Connector assembly | 101 |
| Connector body | 11 |
| Flange portion | 12 |
| Water inlet connector | 13 |
| Water outlet connector | 14 |
| Water inlet cover plate | 151 |
| Water inlet clip | 161 |
| Water outlet Cover plate | 152 |
| Water outlet clip | 162 |
| First inlet cavity | 111 |
| First outlet cavity | 112 |
| Water inlet boss | 17 |
| Water outlet boss | 18 |
| First accommodating cavity | 171 |
| Second accommodating cavity | 181 |
| Gap | 182 |
| Third accommodating cavity | 19 |
| Hanging piece | 113 |
| Flange hole | 121 |
| Fourth accommodating cavity | 122 |
| Transition section | 123 |
| Filter element assembly | 102 |
| End cover | 20 |
| End cover body | 21 |
| First connecting end | 22 |
| Flange structure | 23 |
| Fifth accommodating cavity | 24 |
| End cover o-ring groove | 211 |
| End cover o-ring | 212 |
| First support portion | 25 |
| Second support portion | 26 |
| Concave stop | 221 |
| Fliter element cover | 30 |
| water inlet body | 31 |
| water outlet body | 32 |
| Mounting portion | 33 |
| Water inlet | 311 |
| Second inlet cavity | 312 |
| Water inlet o-ring groove | 313 |
| Water outlet channel | 321 |
| Water outlet o-ring groove | 322 |
| Water outlet o-ring | 323 |
| Receiving groove | 331 |
| Second outlet cavity | 332 |
| T-type inlet channel | 301 |
| Filter element | 40 |
| Water purification cavity | 41 |
| Casing | 50 |
| The fourth inlet cavity | 51 |
| Convex stop | 52 |
| Filter element bottom | 60 |

The present disclosure is further described in the following specific embodiments.

### DETAILED DESCRIPTION OF THE EMBODIMENTS

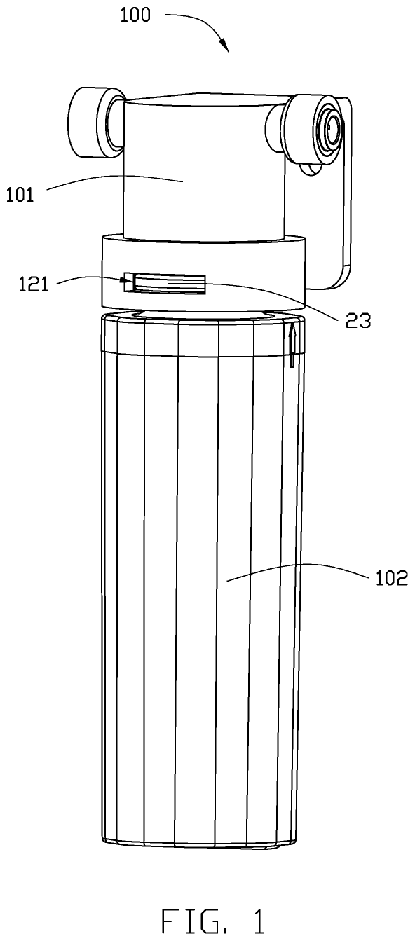

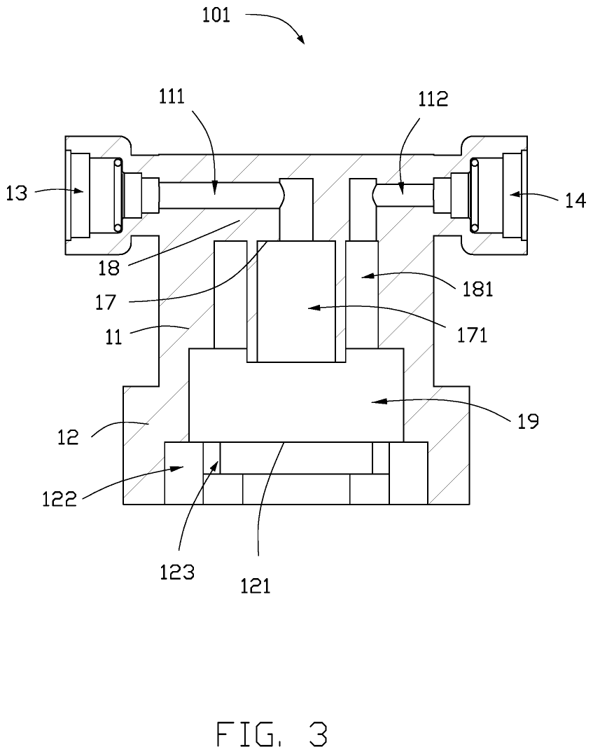

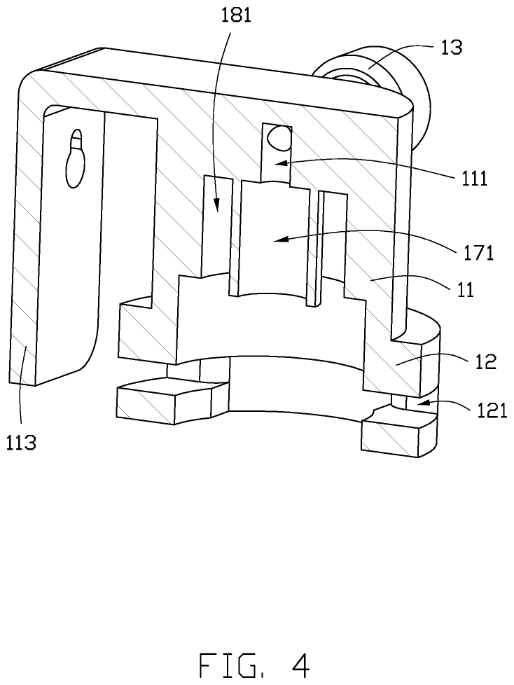

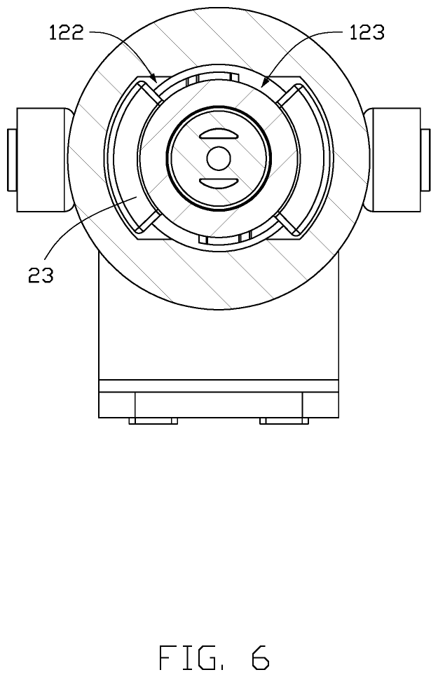

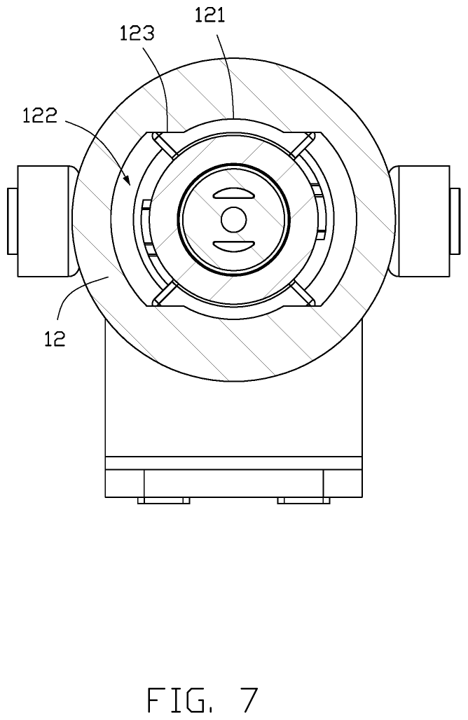

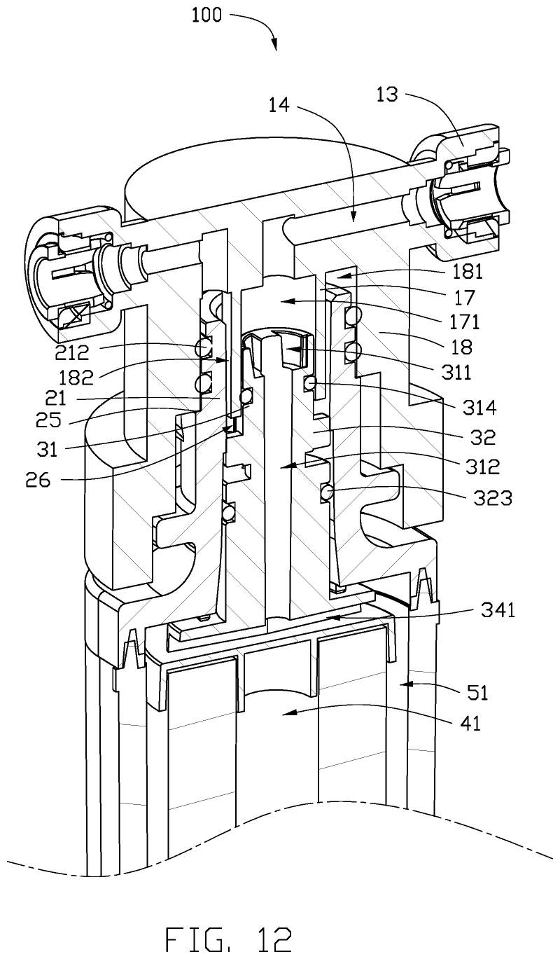

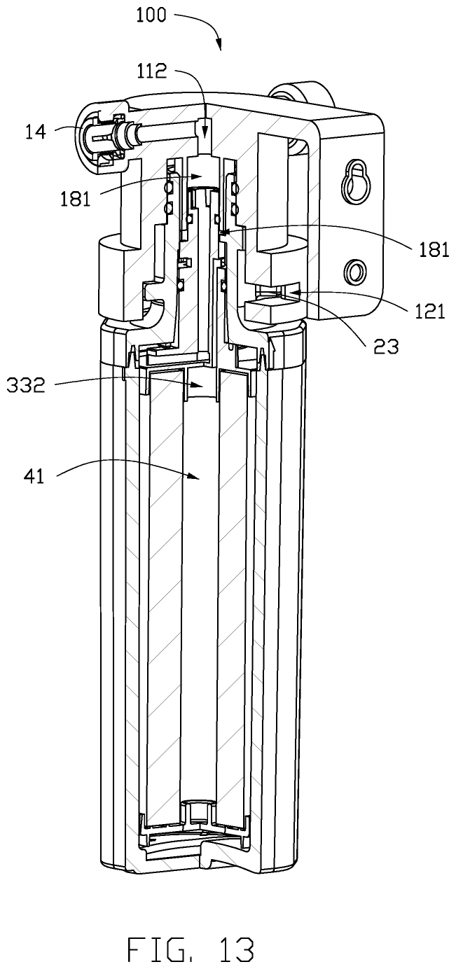

The technical solutions in the embodiments of the present disclosure will be described clearly and completely with FIGS. 1-13. It is apparent that the described embodiments are only a part of the embodiments of the present disclosure, not all of the embodiments. Based on the embodiment of the present disclosure, all other embodiments obtained by ordinary skilled person in the art without creative labor belong to the scope of the present disclosure.

The location words “first” and “second” used in this paper are defined by the position of each element of the water purifier, but not limited.

Unless otherwise defined, all technical and scientific terms used herein have the same meanings as those commonly understood by those skilled in the art of the present disclosure. The terms used in the specification of the present disclosure are only for the purpose of describing specific embodiments, and are not intended to limit the present disclosure.

As shown in FIG. 1, the present disclosure is to provides a water purifier 100, which includes at least one connector assembly 101 and at least one filter element assembly 102 connected to the connector assembly 101. Wherein, the connector assembly 101 cooperates with the filter element assembly 102 to complete the purification of the water before filtration.

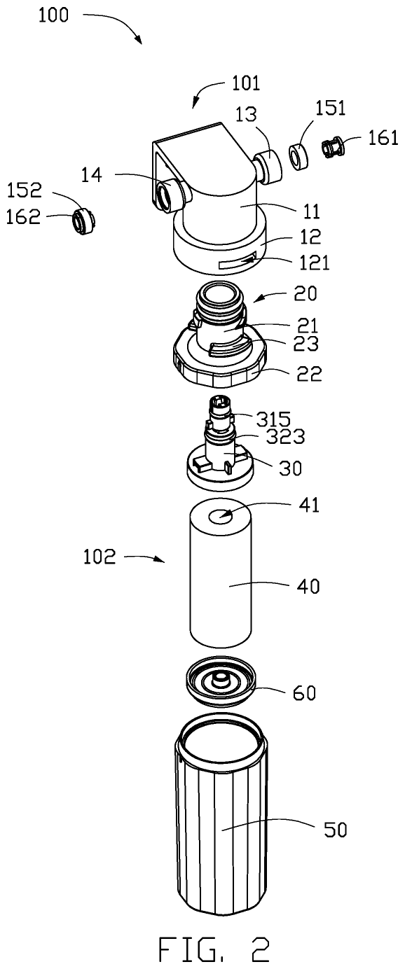

Please refer to FIGS. 2-4, the connector assembly 101 includes a connector body 11, a flange 12, and a water inlet connector 13 and a water outlet connector 14 formed on the connector body 11. The connector portion 11, the flange portion 12, the water inlet connector 13 and the water outlet connector 14 are integrally formed. In this embodiment, the size of the flange portion 12 is larger than the size of the connector body 11.

Wherein, the water inlet connector 13 is a water inlet port of the water purifier 100, or as a connection port connected to another connector assembly 101 to purify the water before filtration in a hierarchical manner.

Wherein, the water outlet connector 14 is a water outlet port of the water purifier 100 or a connection port connected with another connector assembly 101 to purify the water before filtration in a hierarchical manner.

Wherein, the water inlet cover plate 151, the water inlet clip 161 and the water inlet sealing ring (not shown in the figure) are also arranged in the water inlet connector 13. The water inlet cover plate 151 is accommodated in the water inlet connector 13, the water inlet clip 161 is accommodated in the water inlet cover plate 151, and the water inlet sealing ring is located in the gap between the water inlet cover plate 151, the water inlet clip 161 and the water inlet connector 13 to seal the water inlet connector 13, the water inlet cover plate 151 and the water inlet clip 161, so as to prevent the overflow of the water before filtration.

Wherein, the water outlet connector 14 is also provided with a water outlet cover plate 152, a water outlet clip 162 and a water outlet sealing ring (not shown in the figure). The water outlet cover plate 152 is accommodated in the water outlet connector 14, the water outlet clip 162 is accommodated in the water outlet cover plate 152, and the water outlet sealing ring is located in the gap between the water outlet cover plate 152, the water outlet clip 162 and the water outlet connector 14 to seal the water outlet connector 14, the water outlet cover plate 152 and the water outlet clip 162, so as to prevent the overflow of the water before filtration.

Wherein, the connector body 11 further includes a first water inlet cavity 111 and a first water outlet cavity 112, the first water inlet cavity 111 is communicated with the water inlet connector 13, and the first water outlet cavity 112 is communicated with the water outlet connector 14. In this embodiment, the first water inlet cavity 111 and the first water outlet cavity 112 are L-shaped.

Wherein, the interior of the connector assembly 101 is also provided with a water inlet boss 17, a water outlet boss 18 arranged around the water inlet boss 17 and a third accommodating cavity 19, the interior of the water inlet boss 17 is provided with a first accommodating cavity 171, and the interior of the water outlet boss 18 is provided with a second accommodating cavity 181. The first accommodating cavity 171, the second accommodating cavity 181 and the flange hole 121 are respectively communicated with the third accommodating cavity 19. The first accommodating cavity 171 is communicated with the first water inlet cavity 111, and the second accommodating cavity 181 is communicated with the first water outlet cavity 112.

Wherein, the water outlet boss 18 is concentric with the water inlet boss 17.

Wherein, the connector assembly 101 also includes a hanging piece 113 integrally formed with the connector body 11. The hanging piece 113, the water inlet connector 13 and the water outlet connector 14 are respectively located on three different surfaces of the connector body 11. The four bosses are located on the back of the hanging piece 113, and there are four through holes on the four boss. The four through holes are used for installing fastening bolts to fix the hanging piece 113.

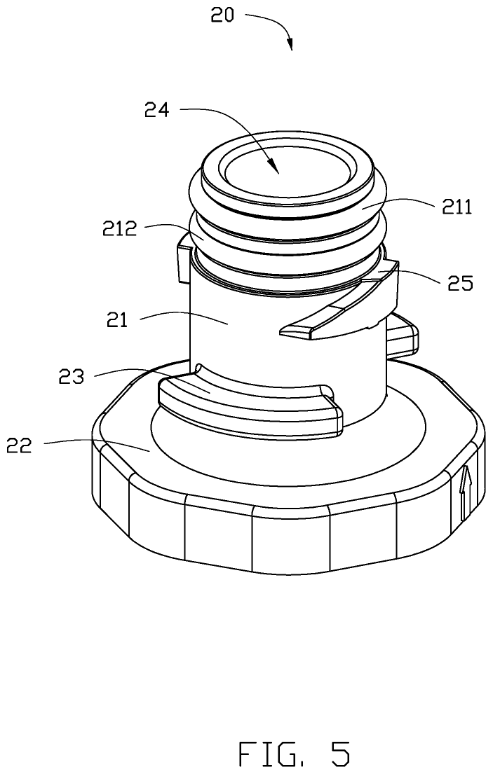

Referring to FIGS. 5-7, the flange portion 12 is provided with two flange holes 121 and a fourth accommodating cavity 122 communicating with the third accommodating cavity. Two transition sections 123 are formed on the inner wall of the fourth accommodating cavity 122, and the transition sections 123 are located at one end of the two flange holes 121. The flange holes 121 penetrate through the flange portion 12. The flange holes 121 are used to contain the flange structure 23 described below to fasten the connector assembly 101 and the filter element assembly 102 together. The fourth accommodating cavity 122 is used to contain one end of the end cover 20 adjacent to the filter element 40. When one end of the end cover 20 adjacent to the filter element 40 is accommodated in the fourth accommodating cavity 122, and the opposite ends of the two flange structures 21 are respectively butted on the inner wall of the fourth accommodating cavity 122, the end cover 20 is rotated 90° and the flange structure 21 slides into the flange hole 121 through the transition section 123.

In the present embodiment, the two flange holes 121 are in opposite positions. Of course, in other embodiment, the positions of the two flange holes 121 are not limited to opposite positions, and there can also be other positional relationships. In the present embodiment, the flange hole 121 is a C-shaped, and the cross section of the flange hole 121 is rectangular.

Referring to FIGS. 2 and 5-10, the filter element assembly 102 includes an end cover 20, a filter element cover 30, a filter element 40, a casing 50 and a filter element bottom 60. The end cover 20 is accommodated and fixed in the second accommodating cavity 181 and the third accommodating cavity 19, the filter element cover 30 is accommodated in the end cover 20 and one end of the filter element cover is accommodated in the first accommodating cavity 171. The filter element 40 is located under the filter element cover 30 and is accommodated in one end of the filter element cover 30 far away from the connector assembly 101. The casing 50 is fixed at one end of the end cover 20 far away from the connector assembly 101, and the filter element 40 is accommodated in the casing 50. The filter element bottom 60 is accommodated in the casing 50, and one end of the filter element bottom is connected to one end of the filter element 40 far away from the filter element cover 30, and the other end is connected with the rib of the casing 50.

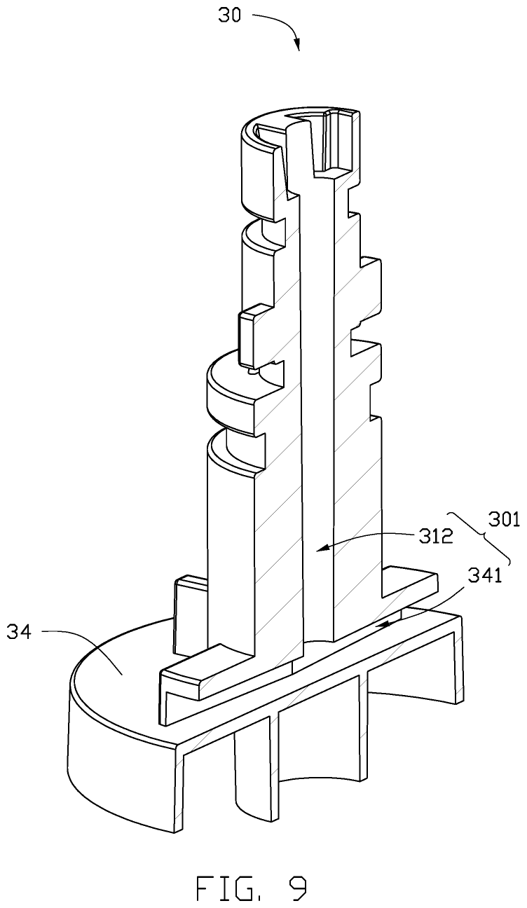

Specifically, refer to FIGS. 5 and 9, the end cover 20 includes an end cover body 21, a first connecting end 22, at least two flange structures 23, at least two first support portions 25, and at least two second support portions 26. The end cover body 21 is fixed on the first connecting end 22. The flange structure 23 is fixed on the end cover body 21 and in a opposite position. The first support portion 25 is fixed on the first connecting end 22 and higher than the flange structure 23. The end cover 20 further includes a fifth accommodating cavity 24, and the second support portion 26 is fixed on the inner wall of the fifth accommodating cavity 24. Wherein, the end face of the water outlet boss 18 facing the third accommodating cavity 19 is arranged on the first support portion 25, and the second support portion 26 is arranged on the end face of the water outlet body 32 far away from the filter element 40.

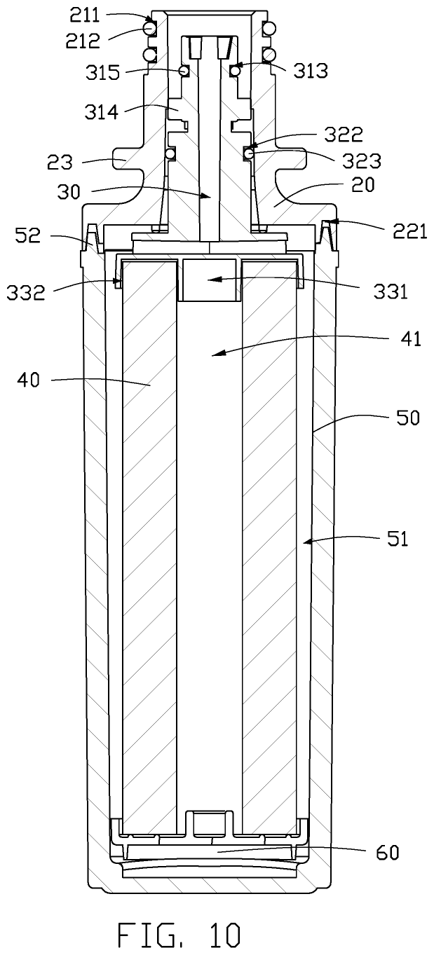

Referring to FIG. 10-13, at least one end cover o-ring groove 211 is formed at the position higher than that of the first support portion 25 on the end cover body 21, and an end cover o-ring 212 is formed in the end cover o-ring groove 211. The end cover body 21 is accommodated in the third accommodating cavity 19 and the second accommodating cavity 181. There is a gap 182 between the inner wall of the end cover body 21 and the inner wall of the second accommodating cavity 181. And the gap 182 is a part of the second accommodating cavity 181 and can be used as a part of the water outlet channel. The end cover o-ring 212 is closely attached to the inner wall of the second accommodating cavity 181 to form a scaling structure, thereby preventing the leakage of purified water. Wherein, the flange structure 23 is accommodated in the flange hole 121 to lock the connector assembly 101 and the filter element assembly 102.

In the present embodiment, the flange structure 23 is fan-shaped.

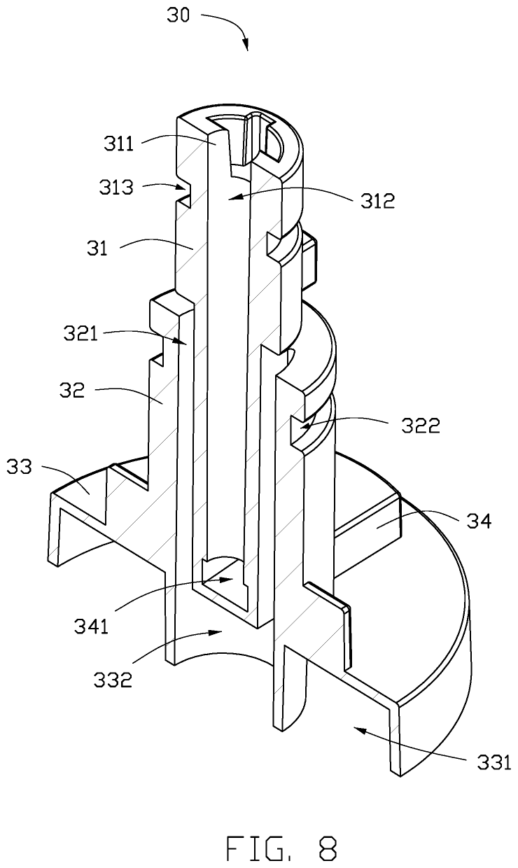

Refer to FIGS. 8-13, wherein the filter element cover 30 includes a water inlet body 31, a water outlet body 32, two extension portions 34 and a second connecting end 33. The water outlet body 32 is arranged around one end of the water inlet body 31, the two extension portions 34 are arranged around one end of the water outlet body 31, the water outlet body 32 and the two extension portions 34 are arranged on the second connecting end 33. The filter element cover 30 is accommodated in the fifth accommodating cavity 24 of the end cover 20. The water inlet body 31 is accommodated in the first accommodating cavity 171. The water inlet body 31 is provided with a second water inlet cavity 312. The second water inlet cavity 312 is communicated with the first accommodating cavity 171. The second water outlet body 32 is provided with a water outlet channel 321. The water outlet channel 321 is communicated with the gap 182. Each of the extension portions 34 is provided with a third water inlet cavity 341, and the second water inlet cavity 312 and the third water inlet cavity 341 together form a T-shaped water inlet channel 301. The T-shaped water inlet channel 301 can divide the water before filtration flowing into the second water inlet cavity 312 and the third water inlet cavity 341 separately.

Wherein, the water inlet body 31 is also provided with a water inlet 311. The water inlet 311 is communicated with the first accommodating cavity 171 and the second water inlet cavity 312.

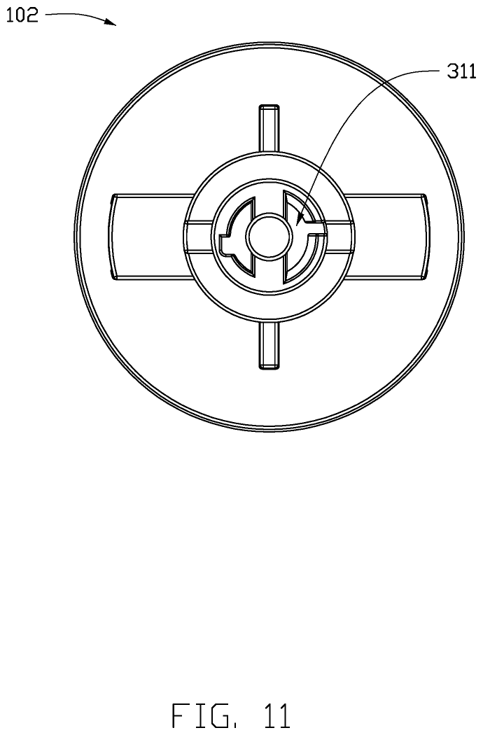

Referring to FIG. 11, the water inlet 311 is an asymmetrical arc structure with protrusions.

Wherein, at least one water inlet o-ring groove 313 is also formed on the outer wall of the water inlet body 31, and the water inlet o-ring 314 is formed in the water inlet o-ring groove 313, and the water inlet o-ring 314 is closely attached to the inner wall of the first accommodating cavity 171 to form a sealing structure, so as to prevent the leakage of the water before filtration.

Wherein, at least one water outlet o-ring groove 322 is formed on the outer wall of the water outlet body 32, and a water outlet o-ring 323 is formed in the water outlet o-ring groove 322, and the water outlet o-ring 323 is closely attached to the inner wall of the fifth accommodating cavity 24 of the end cover 20 to form a sealing structure, thereby preventing the leakage of the purified water.

Wherein, the mounting portion 33 is provided with a receiving groove 331 and a second water outlet cavity 332. The second water outlet cavity 332 is directly facing the second water inlet cavity 312, and the receiving groove 331 is arranged around the second water outlet cavity 332. The second water outlet cavity 332 is communicated with the water outlet channel 321.

Referring to FIGS. 10-11, the filter element 40 is provided with a water purification cavity 41. One end of the filter element 40 is accommodated in the receiving groove 331. The water purification cavity 41 is communicated with the second water outlet cavity 332.

In this method, the filter element 40 is a carbon rod.

Referring to FIGS. 10, 12-13, the casing 50 is a hollow casing. One end of the casing 50 is provided with a convex stop 52, and the casing 50 is connected to the concave stop 221 of the end cover 20 by the convex stop 52. The concave stop 221 is engaged with the convex stop 52 to connect the casing 50 and the end cover 20 detachably. Wherein, the filter element 40 is accommodated in the casing 50. A fourth water inlet cavity 51 is arranged between the inner wall of the casing 50 and the outer wall of the filter element 40. The fourth water inlet cavity 51 is communicated with the third water inlet cavity 341. The bottom 60 of the filter element is accommodated in the casing 50, and one end of the bottom 60 of the filter element is connected to one end of the filter element 40 far away from the filter element cover 30, and the other end is connected with the rib of the casing 50 to seal the water purification cavity 41, so as to prevent the leakage of the purified water.

The water before filtration enters into the first water inlet cavity 111 from the water inlet connector 13, and flows into the water inlet 311 and the second water inlet cavity 312 in sequence, the water are divided into two flows in the third water inlet cavity 341, and then the water flows into the fourth water inlet cavity 51. The water before filtration in the fourth water inlet cavity 51 permeates into the water purification cavity 41 through the small holes in the filter element 40 to realize the filtration of the water before filtration, such that the purified water is obtained. The purified water in the water purification cavity 41 flows through the second water outlet cavity 332, the water outlet channel 321 and the gap 182 in sequence, and then flows into the first water outlet cavity 112, and finally flows out from the water outlet connector 14.

The water purifier provided by the present disclosure, 1) the flange structure with a fan-shape can directly enter the flange hole in a rotating way to cooperate with the flange hole to connect the connector assembly with the filter element assembly, that is, the flange structure can still slide out from the flange hole when the flange structure rotates in the opposite direction, so that the connector assembly and the filter element assembly can be disassembled without tools; 2) T-type inlet channel is used to separate the water before filtration and then enter the filter element to realize water purification. And the gas generated when water before filtration directly enters the water inlet is decomposed into small bubbles after passing through the filter element, with the same filtering accuracy as that of the filter element, and is discharged from the water outlet channel to reduce the noise of the filter element.

It is understandable that for those of ordinary skill in the art, various other corresponding changes and modifications can be made according to the technical concept of the present disclosure, and all these changes and modifications shall belong to the scope of the claims of the present disclosure.

What is claimed is:

1. A water purifier, comprising:
a connector assembly, wherein the connector assembly comprises a connector body and a flange portion integrally formed with the connector body; the connector body comprises a first water inlet cavity and a first water outlet cavity; the flange portion is provided with two flange holes; and
a filter element assembly, wherein the filter element assembly comprises:
an end cover accommodated in the connector assembly, an outer wall of the end cover is provided with two flange structures, and the two flange structures are respectively accommodated in the two flange holes;
a filter element cover accommodated in the end cover, the filter element cover having a T-shaped water inlet channel and a water outlet channel that is not connected to the T-shaped water inlet channel, the T-shaped water inlet channel is communicated with the first water inlet cavity, and the water outlet channel is communicated with the first water outlet cavity;
a filter element fixed at one end of the filter element cover, the filter element having a water purification cavity, the water purification cavity is communicated with the water outlet channel; and
a casing fixed on the end cover, a fourth water inlet cavity is provided between the casing and the filter element, and the fourth water inlet cavity is communicated with the T-shaped water inlet channel; water before filtration enters the fourth water inlet cavity through the first water inlet cavity and the T-shaped water inlet channel, then passes through the filter element and enters the water purification cavity to purify, and then flows out from the first water outlet cavity through the water outlet channels.

2. The water purifier according to claim 1, wherein the flange hole is C-shaped, the flange structure is fan-shaped, and the flange structure is configured to rotate into the flange hole when the end cover is accommodated into the connector assembly.

3. The water purifier according to claim 1, wherein the flange portion further comprises a fourth accommodating cavity, and a upper side and a lower side of an inner wall of the fourth accommodating cavity are provided with two transition sections, and the transition section is located at one end of the two flange holes, the fourth accommodating cavity is used to accommodate the flange portion, when the flange portion is accommodated in the fourth accommodating cavity and two ends opposite to each other of the flange structure are abutted on the inner wall of the fourth accommodating cavity respectively, the end cover is rotated by 90°, and the flange structure slides into the flange hole through the transition section.

4. The water purifier according to claim 1, wherein an interior of the connector body further comprises a water inlet boss, a water outlet boss surrounding the water inlet boss, and an interior of the water inlet boss is provided with a first accommodating cavity communicating with the first water inlet cavity, an interior of the water outlet boss is provided with a second accommodating cavity communicating with the water outlet cavity; an interior of the connector assembly is provided with a third accommodating cavity, the first accommodating cavity, the second accommodating cavity and the flange hole are respectively communicated with the third accommodating cavity; the end of the filter element cover far away from the filter element is accommodated in the first accommodating cavity, the T-shaped water inlet channel is communicated with the first accommodating cavity; the end of the end cover away from the filter element is accommodated in the second accommodating cavity and the third accommodating cavity, the water outlet channel is communicated with the second accommodating cavity.

5. The water purifier according to claim 4, wherein the filter element cover comprises a water inlet body, a water outlet body, two extension portions and a second connecting end, the water outlet body is arranged around one end of the water inlet body, the extension part is arranged around one end of the water outlet body, the water outlet main body and the two extension portions are arranged on the second connecting end, a second water inlet cavity is provided in the water inlet body, the water outlet channel is located on the water outlet body, and each of the extension portions is provided with a third water inlet cavity, the second water inlet cavity and the third water inlet cavity together form the T-shaped water inlet channel.

6. The water purifier according to claim 5, wherein at least one water inlet o-ring is provided between the water inlet body and an inner wall of the first accommodating cavity, and at least one water outlet o-ring is provided between the water outlet body and the end cover, and at least one end cover o-ring is provided between the end cover and an inner wall of the second accommodating cavity.

7. The water purifier according to claim 5, wherein the water inlet body is provided with a water inlet, and the water inlet is communicated with the first water inlet cavity and the second water inlet cavity.

8. The water purifier according to claim 7, wherein the water inlet is an asymmetrical arc structure with protrusions.

9. The water purifier according to claim 1, wherein the end cover comprises a first connecting end, and a surface of the flange portion at one end away from the water outlet cavity is in contact with a surface of the first connecting end of the end cover facing to the flange portion.

10. The water purifier according to claim 9, wherein a section of the end cover away from the connector assembly is provided with a concave stop, one end of the casing is provided with a convex stop, and the concave stop cooperates with the convex stop to connect the end cover and the casing together.

11. The water purifier according to claim 9, wherein the water purifier further comprises a filter element bottom, the filter element bottom is located in the casing, and one end of the filter element bottom is connected to one end of the filter element away from the filter element cover, and the other end is connected and matched with a rib of the casing.
